(19) United States
(12) Patent Application Publication
(10) Pub. No.: US 2015/0130835 A1
(43) Pub. Date: May 14, 2015

(54) INTERACTIVE AUGMENTED REALITY FOR MEMORY DIMM INSTALLATION

(71) Applicant: International Business Machines Corporation, Armonk, NY (US)

(72) Inventors: Amanda J. Daly, Durham, NC (US); Cynthia M. Grosser, Apex, NC (US); Paul D. Kangas, Raleigh, NC (US); Dale N. Weiler, Holly Springs, NC (US)

(73) Assignee: International Business Machines Corporation, Armonk, NY (US)

(21) Appl. No.: 14/077,343

(22) Filed: Nov. 12, 2013

Related U.S. Application Data
(63) Continuation of application No. 14/076,633, filed on Nov. 11, 2013.

(51) Int. Cl. G06T 19/00; G06T 1/60

(52) U.S. Cl. CPC G06T 19/006; G06T 1/60
USPC 345/633

(57) ABSTRACT

Digital images are captured of uninstalled memory modules, an identifying portion of a target computer system, and empty memory module sockets within the target computer system. The captured digital images are analyzed to identify each of the uninstalled memory modules and the number and type of empty memory module sockets. A predetermined set of installation rules associated with the target computer system are used to determine a memory module configuration that identifies the uninstalled memory modules to be installed in the empty memory module sockets. Real-time digital video of a user installing each of the memory modules in one of the empty memory module sockets is captured and displayed on a display device. The displayed digital video is augmented with a computer generated graphic element or audio identifying which empty memory module socket should receive a particular memory module. Other pluggable components may be similarly configured and installed.

### CROSS-REFERENCE TO RELATED APPLICATIONS

This application is a continuation of U.S. patent application Ser. No. 14/076,633 filed on Nov. 11, 2013, which application is incorporated by reference herein.

### BACKGROUND

1. Field of the Invention

The present invention relates to methods of using augmented reality to assist in the performance of tasks.

2. Background of the Related Art

A memory module is a set of dynamic random access memory (DRAM) integrated circuit chips mounted on a printed circuit board having a series of electrical contacts along one edge of the printed circuit board. Each memory module is installed by inserting the edge with the electrical contacts into a memory module socket on another printed circuit board, such as a motherboard. Accordingly, electrical contacts on the memory module align and make contact with electrical contacts within the memory module socket, such that the memory module is installed for communication with a memory controller.

Although memory modules of various types are made, a common type of memory module is the dual inline memory module (DIMM). Memory modules may also vary, for example, according to their speed, capacity and form factor. All of these characteristics of a memory module must be compatible with the memory module socket in which the memory module is installed and must be compatible with the memory controller that communicates with memory module through the memory module socket.

### BRIEF SUMMARY

One embodiment of the present invention provides a method comprising capturing digital images of a plurality of uninstalled memory modules, an identifying portion of a target computer system, and one or more empty memory module sockets within the target computer system. The method also analyzes the captured digital images to identify each of the uninstalled memory modules, and the number and type of empty memory module sockets. A predetermined set of installation rules associated with the target computer system is obtained and applied to determine at least one memory module configuration that identifies one or more of the uninstalled memory modules to be installed in the one or more empty memory module sockets. The method captures real-time digital video of a user installing each of the one or more memory modules in one of the empty memory module sockets, and displays the real-time digital video on a display device, wherein the digital video is augmented with a computer generated graphic element, and wherein the computer generated graphic element provides a visual identification of which one of the empty memory module sockets should receive a selected one of the memory modules.

Another embodiment of the present invention provides a method comprising using a camera to capture digital images of a plurality of uninstalled pluggable components and a target computer system including one or more empty sockets within the target computer system for receiving the pluggable components. The method analyzes the captured digital images to identify each of the uninstalled pluggable components, the computer system, and the number and type of empty sockets. A predetermined set of pluggable component installation rules associated with the target computer system are obtained and applied to determine at least one configuration that identifies one or more of the uninstalled pluggable components to be installed in the one or more empty sockets. The camera is used to capture real-time digital video of a user installing each of the pluggable components in one of the empty sockets. The real-time digital video is displayed on a display device augmented with a computer generated graphic element, wherein the computer generated graphic element provides a visual identification of which one of the empty sockets should receive a selected one of the pluggable components.

### BRIEF DESCRIPTION OF THE SEVERAL VIEWS OF THE DRAWINGS

FIG. 1 is a block diagram of the components of a mobile device in accordance with one embodiment of the invention.

FIG. 2 is a diagram of the mobile device having a display screen displaying uninstalled memory modules that are within the field of view of a camera.

FIG. 3 is a diagram of a target computer system having a plurality of empty memory module sockets.

FIG. 4 is a diagram of the mobile device displaying the memory module sockets within the field of view of the mobile device's camera before installation of a first memory module.

FIG. 5 is a diagram of the mobile device displaying the memory module sockets within the field of view of the camera after installation of the first memory module into one of the target memory module sockets.

FIG. 6 is a flowchart of a method in accordance with one embodiment of the present invention.

### DETAILED DESCRIPTION

One embodiment of the present invention provides a computer program product including computer readable program code embodied on a computer readable storage medium. The computer program product comprises: computer readable program code for capturing digital images of a plurality of uninstalled memory modules, an identifying portion of a target computer system, and one or more empty memory module sockets within the target computer system; computer readable program code for analyzing the captured digital images to identify each of the uninstalled memory modules, and the number and type of empty memory module sockets; computer readable program code for obtaining a predetermined set of installation rules associated with the target computer system; computer readable program code for applying the predetermined installation rules to determine at least one memory module configuration that identifies one or more of the uninstalled memory modules to be installed in the one or more empty memory module sockets; computer readable program code for capturing real-time digital video of a user installing each of the one or more memory modules in one of the empty memory module sockets; and computer readable program code for displaying the real-time digital video on a display device and augmenting the digital video with a computer generated graphic element, wherein the computer generated graphic element provides a visual identification of which one of the empty memory module sockets should receive a selected one of the memory modules.

The computer program product may be loaded into memory and executed by a processor of a computer system in communication with a camera and a display screen. Preferably the camera and the display screen are coupled to the computer system through input/output ports of desktop or notebook type computer system, or perhaps integrated into a mobile device type computer system such as a tablet computer or smart phone. The computer system may store the data and logic necessary to perform the present invention, or the computer system may access the data and logic through a network.

While the computer program product of the present invention is executed by a computer system, embodiments of the invention deal with the installing memory modules to achieve a memory module configuration in a computer system. References to a “computer system” within this disclosure may refer to either computer system, depending upon the context of the reference. However, in much of the disclosure, the computer system that is executing the computer program product is described as a “mobile device” and memory modules are being installed in a computer system referred to as the “target computer system.”

Embodiments of the invention may identify the memory modules in the image using object recognition or by reading text, a bar code, or a radio frequency identification (RFID) tag on each individual memory modules. A text description, such as a part number of the memory module, may be preferred since some of the performance characteristics of the memory module may not be reflected in a unique form factor. Some combination of object recognition and reading text or bar codes may also be implemented, perhaps one technique being used verify identity determined by another technique.

The mobile device may identify a memory module by reading a unique barcode secured to the memory module, wherein the mobile device stores or has access to a table that associates each unique barcode with an identification of the memory module. Other markings, features, codes or labels may similarly be used to identify a memory module. Alternatively, the mobile device may identify a memory module in an image captured by the camera using object recognition. Objection recognition is the task of finding and identifying objects in an image or video sequence. For example, objection recognition methods based on appearance may use edge detection and matching with predetermined templates, greyscale matching, gradient matching, histograms of receptive field responses, or model bases. In the context of the present invention, the task of finding and identifying the memory module sockets is relatively simple, since the size and shape of the memory module sockets is very distinctive relative to other components of the target computer system. Once the memory module is identified, it may be represented by a numerical designator, such as the memory module's part number.

The memory modules, empty memory module sockets, even the target computer system which needs memory installed can all be identified from the digital image and quantified, then compared with a database of known things used by this invention. In general, the particular lines in the image, their angles relative to other lines, relative colors between adjacent areas in the memory modules, presence of text, etc. may be analyzed and reduced to points of numeric minutia (similar to analyzing a finger print). For example, DIMM modules, DIMM sockets, and perhaps the appearance of the outside enclosure of the target computer system may already have been processed into numeric minutia patterns and stored in a database.

A memory module may be identified by the text markings on the module, such as a bar code label or a supplier part number label. However, there may be other identifiable markings on the memory module to discern a memory module that is particularly difficult to identify. These other identifiable markings may include a supplier graphical marking or identification in white printing, a supplier logo in copper on the printed circuit board, and the part numbers of the memory chips themselves. The memory module sockets and computer enclosures may be identified by vector analyzed minutia points stored in a database as the “finger print” of the object. For example, previously stored data representing these objects may be compared in real time as new, unknown images are captured by the camera of the mobile device.

For any given inventory of memory modules, a first step may be to identify which memory modules are compatible with the empty sockets of the target computer system. Furthermore, the target computer system may limit the types of memory modules that are compatible with the system, such as due to the system including a particular memory controller. Determining whether a memory module is compatible with the empty sockets may involve searching a memory module/socket/system compatibility table for each of the identified memory modules (i.e., part number). Optionally, the mobile device may provide audio or video output to a user regarding the suitability of the memory module inventory. An example of such audio might state “Memory available to install is 96 GBs. Four DIMMs of P/N 12D3456 are low speed and could be replaced with four of P/N 34D5678 for increased performance.”

Each memory module configuration may identify the specific memory module that may be installed in each specific empty socket. Furthermore, the codified memory module installation rules may be used to determine which of the multiple possible memory module configurations would provide the highest performance.

In order to determine one or more possible configurations of the memory modules in the sockets of the target computer system, the mobile device will preferably store or have access to a database of memory module types and sizes and a codified set of installation rules required by the target computer system. The installation rules are used to determined one or more possible configurations of the identified memory modules in the identified sockets of the target computer system. Each configuration will preferably specify which of the available memory modules should be installed in each of the sockets. If multiple possible configurations are identified, then the mobile device may further identify the configuration that will provide optimal memory access performance. The memory module installation rules are mostly affected by the requirements of a memory controller integrated circuit used in the mother board design of the target computer system, such as a server or workstation, and are called out in a datasheet of the memory controller. Accordingly, these installation rules may benefit from periodic updates as new memory controller designs are developed and as new memory module technology is introduced.

While the invention applies the predetermined installation rules to determine at least one memory module configuration, embodiments of the invention may also determine multiple memory module configurations. Accordingly, computer readable program code may cause mobile device to display a prompt requesting the user to select from among the multiple memory module configurations.

Optionally, the mobile device may applying the predetermined installation rules to determine a memory module configuration that provides the target computer system with a maximum memory performance given the uninstalled memory modules that are available and the empty memory module sockets that are available. In a further option, the mobile device may apply the predetermined installation rules to determine a memory module configuration that provides the target computer system with maximum memory performance if one or more additional memory modules were available. Still further, the mobile device may apply the predetermined installation rules to determine a memory module configuration that provides the target computer system with maximum memory performance if one or more previously installed memory modules were replaced or substituted. For example, if the available memory modules include eight 4 GB DIMMs of one part number, and two 4 GB DIMMs of another lower speed part number, then the mobile device may provide audible or video output highlighting that the two lower speed DIMMs are different, although acceptable, and that two more of the faster speed part numbers would increase performance of the target computer system. It may be that the user just picked up slower speed DIMMs unintentionally and only saw they were 4 GB in size.

In a non-limiting example, the installation rules for a hypothetical target computer system (i.e., an Intel SE7501BR2 mother board) may be as follows:
(1) a certain technology of memory DIMM must be supported (i.e., supports only registered DDR266 compliant DIMMs).
(2) a minimum supported memory configuration/size is required (i.e., minimum of 256 MB).
(3) a maximum total configurable memory configuration/size is specified (i.e., maximum of 8 GB).
(4) memory modules must always be added in pairs into the corresponding pairs of memory banks.
(5) memory modules must be added to a particular bank first.
(6) memory modules must be installed in a certain order within a bank of sockets (i.e., starting with the socket physically closest to the memory controller, then the next closest socket, etc.).
(7) memory module sizes within the group of sockets in a bank must be identical (i.e., all DIMMs are 2 GB within one bank, and possibly all 4 GB within a different bank).

In a further embodiment, the memory module configuration may include an installation sequence. In such a situation, the mobile device may display a computer generated graphic element highlighting the memory module that should be installed next in the installation sequence until that memory module has been moved, and then display a computer generated graphic element highlighting the memory module socket that should receive the memory module that has been moved until that memory module has been installed into the memory module socket. Preferably, the camera is aimed so that its field of view displays a live image of the sockets augmented with the computer generated graphic element identifying the target socket. The display of a live image along with computer generated graphics related to the image may be generally referred to as “augmented reality.” Non-limiting examples of the highlighting may include outlining, circling, shading, or use of an arrow to point to the relevant component. Furthermore, the mobile device may display a computer generated graphic element or produce an audible sound indicating whether the installation of the memory module into the memory module socket is consistent with the selected memory module configuration prior to highlighting a further memory module or a further memory module socket in the installation sequence. Alternatively, the highlighting may be supplemented with, or replaced by, an audible (verbal) instruction identifying the memory module and/or memory module socket.

Still further, the mobile device may analyze the digital video to identify the empty memory module socket into which the user is currently installing the selected memory module. Accordingly, the mobile device may execute computer readable program code for determining whether the identified memory module socket is the correct memory module socket into which the selected memory module should be installed according to the selected memory module configuration, and computer readable program code for displaying a computer generated graphic or producing an audible sound indicating whether the selected memory module has been installed into the correct memory module socket.

With the camera aimed at the target socket or all of the sockets, the mobile device may use objection recognition to determine that a memory module has been installed in a particular socket. If the selected memory module configuration specifies that the socket receiving the memory module is the target socket for the memory module picked up by the user, then that memory module has been installed correctly. A computer generated graphic element may be displayed to indicate the correct installation, such as the word “success”, a green dot, or an advancing progress bar. Alternatively, an audible nonverbal or verbal sound may be generated to indicate the correct installation. Each step of the installation may be verified in this manner until the memory module configuration has been completed. In a further example, if the user inserts a particular memory module into the wrong socket (i.e., not the socket identified to receive the particular memory module in accordance with the selected memory module configuration), then a computer generated graphic element may be displayed to indicate the incorrect installation, such as a red X superimposed over the displayed image of the subject memory module, or audible beeps or a verbal command (i.e., to “remove DIMM and insert into the green highlighted socket”) may be provided.

The mobile device may also display real-time data representing the extent of progress toward completing the selected memory module configuration. Various measures of progress may be used, such as the number of memory modules installed. Optionally, the real-time data representing the extent of progress includes the total capacity of all memory modules installed in the computer system. The extent of progress may also be provided in an audible verbal or nonverbal output.

In a still further option, the mobile device may provide feedback on the reason for any leftover memory modules. Non-limiting examples of such reasons may include: insufficient multiples of memory modules based on size, incompatible speed or other memory specifications, such as CAS latency and rank configuration limitations. For Example, a computer generated voice may say: “One memory DIMM of P/N 12D34456 is left over because DIMMs must be installed in pairs; one more DIMM of that P/N is needed.” Similarly, the mobile device may provide a summary of the final configuration of installed memory, perhaps including the total amount of installed memory and relative performance of the configuration based on memory speed and technology. For example, a computer generated voice may say: “96 GBs of memory are installed and is at 80% capacity of the total possible memory.”

References to video images or video display may include either full motion video or still images, and the computer generated graphic elements may be added to either live full motion video or still image. Full motion video is preferred because of the interactive nature of the video may make the installation more intuitive to the user.

While the foregoing discussion, as well as the embodiments shown in the Figures discussed below, are specific to the identification and installation of memory modules, the present invention may also be used to identify and install other uninstalled pluggable components of a computer system. For example, a target computer system may have a motherboard that is compatible with more than one type of processor, where each processor may be identified by a part number. The target computer system may be associated with installation rules governing which type(s) of processor(s) may be installed in the target computer system. Motherboards and other expansion card that include processors, may have additional installation rules, such as requiring that all of the processors on a board must have the same part number. Furthermore, the processor installation, or even memory module installation, may involve installation rules regarding physical orientation so as to avoid installing in an improper orientation. While a processor socket may be ‘keyed’ for the purpose of allowing only one orientation, an image of the user installing the processor or memory module can use object recognition to verify proper orientation and provide feedback to the user regarding correct or incorrect installation.

A further embodiment of the present invention thus provides a computer program product including computer readable program code embodied on a computer readable storage medium, the computer program product comprising computer readable program code for using a camera to capture digital images of a plurality of uninstalled pluggable components and a target computer system including one or more empty sockets within the target computer system for receiving the pluggable components; computer readable program code for analyzing the captured digital images to identify each of the uninstalled pluggable components, the computer system, and the number and type of empty sockets; computer readable program code for obtaining a predetermined set of pluggable component installation rules associated with the target computer system; computer readable program code for applying the predetermined installation rules to determine at least one configuration that identifies one or more of the uninstalled pluggable components to be installed in the one or more empty sockets; computer readable program code for using the camera to capture real-time digital video of a user installing each of the pluggable components in one of the empty sockets; and computer readable program code for displaying the real-time digital video on a display device and augmenting the digital video with a computer generated graphic element, wherein the computer generated graphic element provides a visual identification of which one of the empty sockets should receive a selected one of the pluggable components. Optionally, the pluggable components may be selected from processors, expansion cards, memory modules, and combinations thereof.

An association between two data elements may be a logical association, for example, by storing a logical association between a type of target computer system and the predetermined memory module installation rules for a target computer system of that type. Furthermore, an association might be established by storing the target computer system type or part number in a common record or a list (i.e., a row of a table) along with a memory module part number that is compatible with the target computer system. As another example, an association might be established by storing the part number for the target computer system and the part number for a compatible memory module in separate records using a common reference ID (as in a relational database). The logical association between two data elements can be established using any data storage or programming technique that represents the physical compatibility that the components.

A further embodiment of the present invention provides a method comprising capturing digital images of a plurality of uninstalled memory modules, an identifying portion of a target computer system, and one or more empty memory module sockets within the target computer system. The method also analyzes the captured digital images to identify each of the uninstalled memory modules, and the number and type of empty memory module sockets. A predetermined set of installation rules associated with the target computer system is obtained and applied to determine at least one memory module configuration that identifies one or more of the uninstalled memory modules to be installed in the one or more empty memory module sockets. The method captures real-time digital video of a user installing each of the one or more memory modules in one of the empty memory module sockets, and displays the real-time digital video on a display device, wherein the digital video is augmented with a computer generated graphic element, and wherein the computer generated graphic element provides a visual identification of which one of the empty memory module sockets should receive a selected one of the memory modules.

A still further embodiment of the present invention provides a method comprising using a camera to capture digital images of a plurality of uninstalled pluggable components and a target computer system including one or more empty sockets within the target computer system for receiving the pluggable components. The method analyzes the captured digital images to identify each of the uninstalled pluggable components, the computer system, and the number and type of empty sockets. A predetermined set of pluggable component installation rules associated with the target computer system are obtained and applied to determine at least one configuration that identifies one or more of the uninstalled pluggable components to be installed in the one or more empty sockets. The camera is used to capture real-time digital video of a user installing each of the pluggable components in one of the empty sockets. The real-time digital video is displayed on a display device augmented with a computer generated graphic element, wherein the computer generated graphic element provides a visual identification of which one of the empty sockets should receive a selected one of the pluggable components.

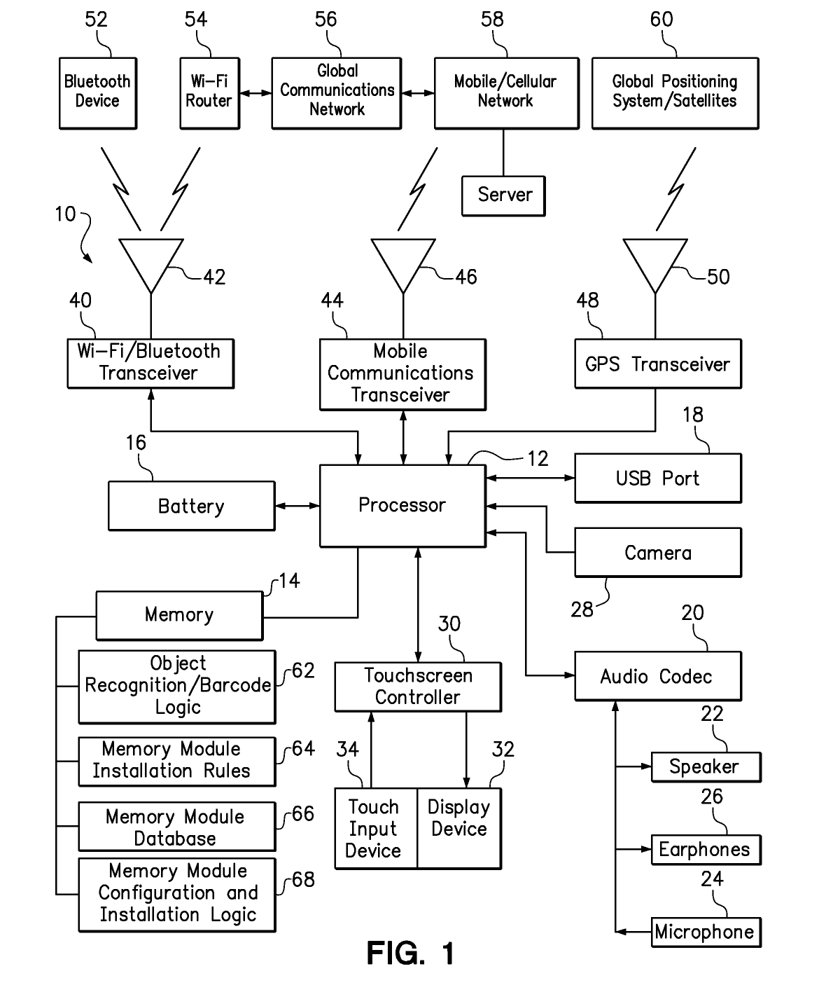

The following embodiment in FIGS. 1-6 is directed to the installation of memory modules, but it should be understood that the present invention may also be used for the installation of any other type of pluggable components or combinations of types of pluggable components to be installed in a target computer system. The present invention provides a unique interface for guiding a user through an installation procedure, while providing instruction and feedback through the steps of the procedure, not just after completion.

FIG. 1 is a block diagram of the components of a mobile device 10, such as a smart phone, capable of implementing one embodiment of the invention. The mobile device 10 may include a processor 12, memory 14, a battery 16, a universal serial bus (USB) port 18, a camera 28, and an audio codec 20 coupled to a speaker 22, a microphone 24, and an earphone jack 26. The device 10 may further include a touchscreen controller 30 which provides a graphical output to the display device 32 and an input from a touch input device 34. Collectively, the display device 32 and touch input device 34 may be referred to as a touchscreen.

The device 10 may also include a Wi-Fi and/or Bluetooth transceiver 40 and corresponding antenna 42 allowing the device to communicate with a Bluetooth device 52 or a Wi-Fi router 54, a mobile communication transceiver 44 and corresponding antenna 46 allowing the device to communicate over a mobile/cellular network 58, and a global positioning system (GPS) transceiver 48 and corresponding antenna 50 allowing the device to obtain signals from a global positioning system or satellites 60. In a non-limiting example, the Wi-Fi router 54 and the mobile/cellular network 58 may be connected to a global communications network 56, such as the Internet. Furthermore, mobile/cellular network 58 may include or access a server for the purpose of storing a table that associates barcodes, RFID tags and text with an identification of the memory module; object recognition data for various memory modules, memory modules, and computer systems; memory module installation rules; and memory module configuration and installation logic. When the mobile device 10 has memory 14 with sufficient capacity, it is preferably to include any or all of these data storage and logic functions within the mobile device itself. As shown, the memory 14 stores an objection recognition and barcode logic module 62, memory module installation rules 64, memory module database 66, and memory module configuration and installation logic 68.

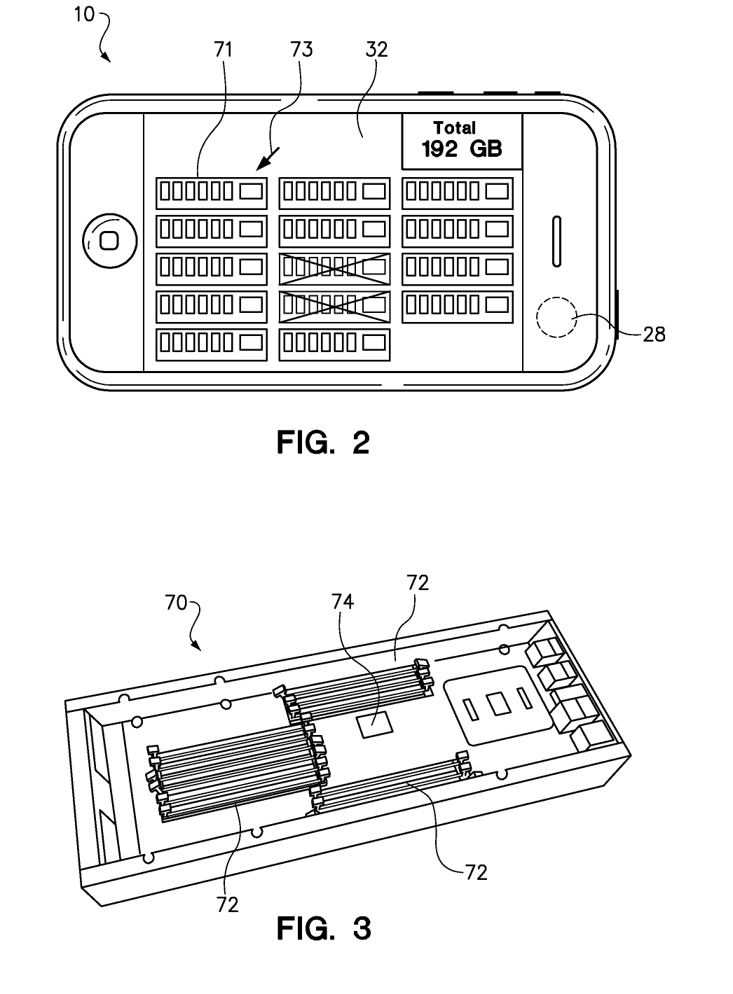

FIG. 2 is a diagram of the mobile device 10 having a display screen 32 displaying uninstalled memory modules that are within the field of view of a camera 28, such as a front-facing camera on the opposite side of the mobile device from the display screen. As shown, a user has spread out the uninstalled memory modules that are available for installation so that the camera can capture an image of the memory modules. In the image shown, the form factor of each memory module is clearly observable so as to facility object recognition, and a label displaying the memory module part number or bar code is also visible for identifying the memory module. After having selecting a memory module configuration for a target computer system, the image is augmented with an “X” superimposed over two of the memory modules that should not be used, and a graphical element (arrow 73) pointing to a memory module 72 that should be installed first. The screen 32 further displays the total amount of memory capacity available to be installed.

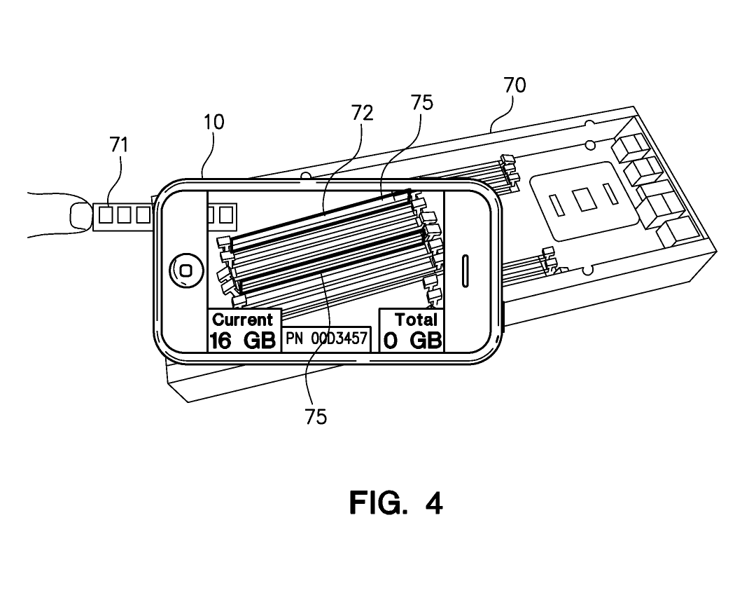

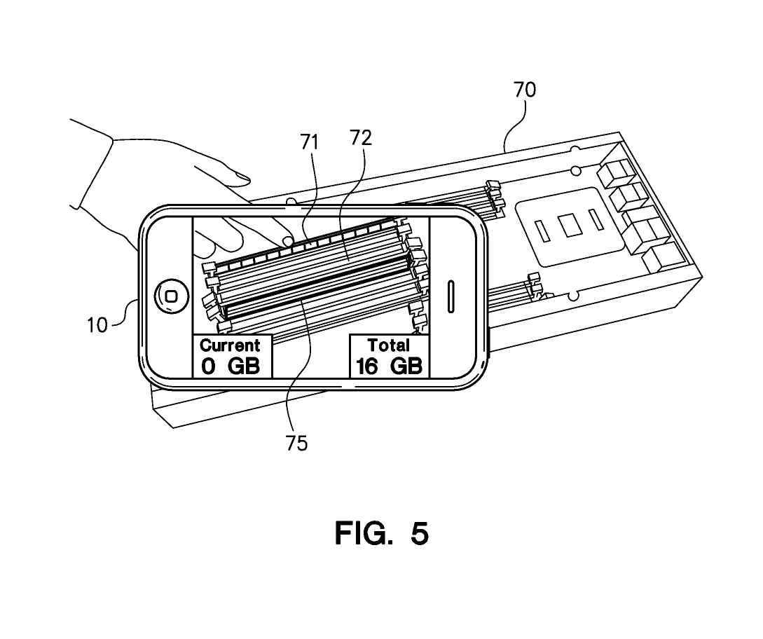

FIG. 3 is a diagram of a target computer system 70 having a plurality of empty memory module sockets 72 (twelve shown). The sockets 72 are coupled to a memory controller 74, which contributes to rules for how memory modules may be installed in the target computer system 70. In accordance with embodiments of the invention, the mobile device 10 (see FIGS. 1 and 2) may capture an image of the target computer system 70 in order to identify the type and number of sockets 72 and identify the target computer system 70. After having captured an image of the memory modules in FIG. 2 and an image of the target computer system 70 in FIG. 3, the present invention is able to identify the memory modules, identify the computer system, obtain the predetermined installation rules for the computer system, and determine one or more memory module configurations. The installation of a selected memory module configuration is discussed in reference to FIGS. 4 and 5, below.

FIG. 4 is a diagram of the mobile device 10 displaying the memory module sockets 72 within the field of view of the mobile device's camera before installation of a first memory module 71. Having already selected a memory module configuration, such as the memory module configuration that provides the target computer system 70 with the greatest memory capacity, and the user having picked up the first memory module 71, the mobile device displays a computer generated graphical element (outlining 75) around two of memory module sockets 72 where the first memory module 71 may be installed consistent with the selected memory module configuration. Furthermore, the screen displays the “Current” part number and memory capacity of the first memory module 71 that is currently being installed, as well as the “Total” amount of memory capacity installed in the target computer system 70.

FIG. 5 is a diagram of the mobile device 10 displaying the memory module sockets 72 within the field of view of the camera after installation of the first memory module 71 into one of the target memory module sockets. The successful installation may be indicated by removing the outlining 75 from the socket where the module was installed, by updating the “Total” amount of memory capacity installed, and showing that there is no “Current” memory module being installed (i.e., 0 GB). The user should then direct the real-time camera to the inventory of memory modules and pick up the next memory module, which may also be highlighted in the augmented display (as in FIG. 2). The next memory module is then installed as shown in FIGS. 4 and 5. This sequence is repeated in order to complete the selected memory module configuration. Depending on the resolution and field of view of the camera, and whether any camera mounting system is used, the mobile device with an integral camera and display may need to pan back and forth between the inventory of memory modules and the memory module sockets of the target computer system.

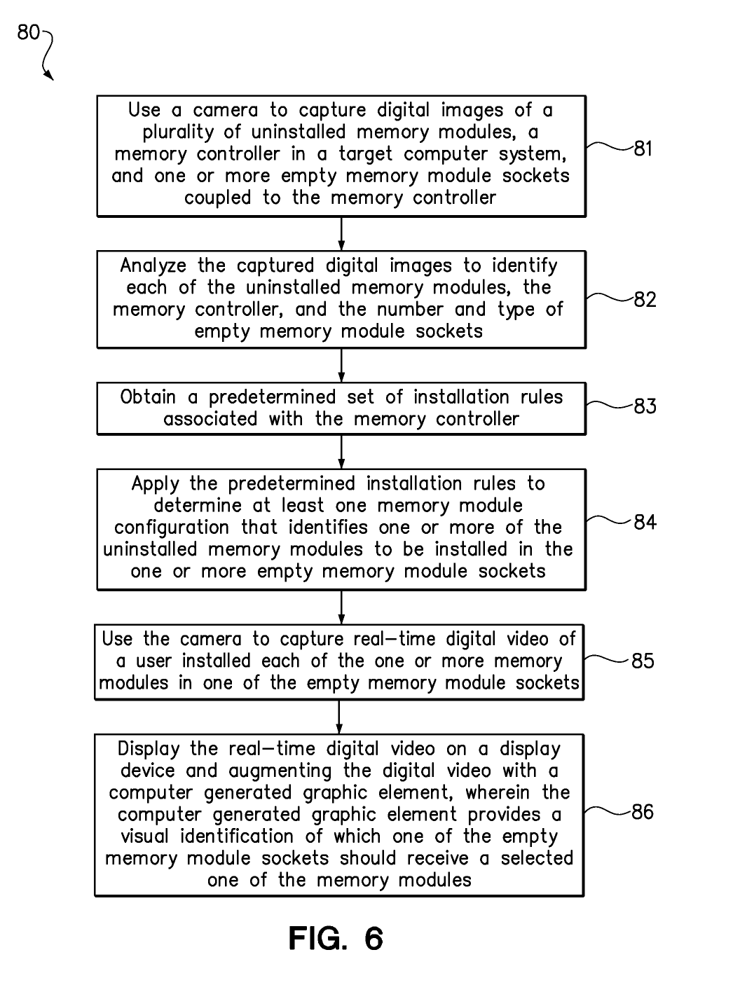

FIG. 6 is a flowchart of a method 80 in accordance with one embodiment of the present invention. In step 81, a camera is used to capture digital images of a plurality of uninstalled memory modules and a target computer system, including one or more empty memory module sockets within the target computer system. In step 82, the captured digital images are analyzed to identify each of the uninstalled memory modules, the target computer system, and the number and type of empty memory module sockets. A predetermined set of installation rules associated with the target computer system are obtained in step 83, then applied in step 84 to determine at least one memory module configuration that identifies one or more of the uninstalled memory modules to be installed in the one or more empty memory module sockets. The camera is used again, in step 85, to capture real-time digital video of a user installing each of the one or more memory modules in one of the empty memory module sockets. In step 86, the real-time digital video is displayed on a display device and augmenting the digital video with a computer generated graphic element, wherein the computer generated graphic element provides a visual identification of which one of the empty memory module sockets should receive a selected one of the memory modules.

Embodiments of the present invention further include computer program products including computer readable program code for implementing or initiating any one or more aspects of the methods described herein. Accordingly, a separate description of the methods will not be duplicated in the context of a computer program product.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention may be described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, and/or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the invention.

The corresponding structures, materials, acts, and equivalents of all means or steps plus function elements in the claims below are intended to include any structure, material, or act for performing the function in combination with other claimed elements as specifically claimed. The description of the present invention has been presented for purposes of illustration and description, but it is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method, comprising:
using a camera to capture digital images of a plurality of uninstalled memory modules and a target computer system including one or more empty memory module sockets within the target computer system;
analyzing the captured digital images to identify each of the uninstalled memory modules, the computer system, and the number and type of empty memory module sockets;
obtaining a predetermined set of installation rules associated with the target computer system;
applying the predetermined installation rules to determine at least one memory module configuration that identifies one or more of the uninstalled memory modules to be installed in the one or more empty memory module sockets;
using the camera to capture real-time digital video of a user installing each of the one or more memory modules in one of the empty memory module sockets; and
displaying the real-time digital video on a display device and augmenting the digital video with a computer generated graphic element, wherein the computer generated graphic element provides a visual identification of which one of the empty memory module sockets should receive a selected one of the memory modules.

2. The method of claim 1, wherein the memory modules in the image are identified by object recognition.

3. The method of claim 1, wherein the memory modules in the image are identified by reading text or a bar code on each individual memory modules.

4. The method of claim 1, wherein the camera and display device are included in a mobile device.

5. The method of claim 1, wherein applying the predetermined installation rules to determine at least one memory module configuration includes determining multiple memory module configurations, the method further comprising:
displaying a prompt requesting the user to select from among the multiple memory module configurations.

6. The method of claim 1, wherein applying the predetermined installation rules to determine at least one memory module configuration, includes determining a memory module configuration that provides the target computer system with a maximum memory performance given the uninstalled memory modules and the empty memory module sockets.

7. The method of claim 1, wherein applying the predetermined installation rules to determine at least one memory module configuration includes determining a memory module configuration that provides the target computer system with maximum memory performance if one or more additional memory modules were available.

8. The method of claim 1, wherein applying the predetermined installation rules to determine at least one memory module configuration includes determining a memory module configuration that provides the target computer system with maximum memory performance if one or more previously installed memory modules were replaced.

9. The method of claim 1, wherein the memory module configuration includes an installation sequence, further comprising:
displaying a computer generated graphic element highlighting the memory module that should be installed next in the installation sequence until that memory module has been moved; and then
displaying a computer generated graphic element highlighting the memory module socket that should receive the memory module that has been moved until that memory module has been installed into the memory module socket.

10. The method of claim 9, further comprising:
displaying a computer generated graphic element indicating whether the installation of the memory module into the memory module socket is consistent with the selected memory module configuration prior to highlighting a further memory module or a further memory module socket in the installation sequence.

11. The method of claim 9, further comprising:
produce an audible sound or visual display indicating whether the installation of the memory module into the memory module socket is consistent with the selected memory module configuration prior to highlighting a further memory module or a further memory module socket in the installation sequence.

12. The method of claim 1, further comprising:
analyzing the digital video to identify the empty memory module socket into which the user is currently installing the selected memory module; and
determining whether the identified memory module socket is the correct memory module socket into which the selected memory module should be installed according to the selected memory module configuration.

13. The method of claim 12, further comprising:
displaying a computer generated graphic indicating whether the selected memory module has been installed into the correct memory module socket.

14. The method of claim 12, further comprising:
producing an audible sound indicating whether the selected memory module has been installed into the correct memory module socket.

15. The method of claim 1, further comprising:
displaying real-time data representing the extent of progress toward completing the selected memory module configuration.

16. The method of claim 15, wherein the real-time data representing the extent of progress includes the total capacity of all memory modules installed in the target computer system.

17. The method of claim 1, further comprising:
analyzing the digital video to identify the physical orientation of the selected memory module and the physical orientation of the empty memory module socket;
determining whether the selected memory module is being installed in a proper orientation relative to the physical orientation of the empty memory module socket; and
producing an audible sound or visual display indicating whether the selected memory module has been installed in the correct physical orientation relative to the physical orientation of the empty memory module socket.

18. A method, comprising:
using a camera to capture digital images of a plurality of uninstalled pluggable components and a target computer system including one or more empty sockets within the target computer system for receiving the pluggable components;
analyzing the captured digital images to identify each of the uninstalled pluggable components, the computer system, and the number and type of empty sockets;
obtaining a predetermined set of pluggable component installation rules associated with the target computer system;
applying the predetermined installation rules to determine at least one configuration that identifies one or more of the uninstalled pluggable components to be installed in the one or more empty sockets;
using the camera to capture real-time digital video of a user installing each of the pluggable components in one of the empty sockets; and
displaying the real-time digital video on a display device and augmenting the digital video with a computer generated graphic element, wherein the computer generated graphic element provides a visual identification of which one of the empty sockets should receive a selected one of the pluggable components.

19. The method of claim 18, wherein the pluggable components are selected from processors, expansion cards, memory modules, and combinations thereof.

20. The method of claim 19, further comprising:
analyzing the digital video to identify the physical orientation of the pluggable component being installed and the physical orientation of the empty socket in which the pluggable component is being installed;
determining whether the pluggable component is being installed in a proper orientation relative to the physical orientation of the empty socket; and
producing an audible sound or visual display indicating whether the selected pluggable component has been installed in the correct physical orientation relative to the physical orientation of the empty socket.
